(19) United States
(12) Patent Application Publication
(10) Pub. No.: US 2014/0227611 A1
(43) Pub. Date: Aug. 14, 2014

(54) Non-Aqueous Secondary Battery

(71) Applicant: Akinobu Nakamura, Tokyo (JP)

(72) Inventor: Akinobu Nakamura, Tokyo (JP)

(73) Assignee: NEC CORPORATION, Tokyo (JP)

(21) Appl. No.: 14/345,900

(22) PCT Filed: Aug. 22, 2012
(86) PCT No.: PCT/JP2012/071168

§ 371 Date: Mar. 19, 2014

(30) Foreign Application Priority Data
Sep. 20, 2011 (JP) 2011-204597

(51) Int. Cl. H01M 10/0569; H01M 10/0525

(52) U.S. Cl. CPC H01M 10/0569; H01M 10/0525
USPC 429/330; 429/326; 429/327

(57) ABSTRACT

The object of the present exemplary embodiment is to provide a non-aqueous secondary battery effectively in which the decomposition of an electrolyte liquid is effectively reduced even under high-voltage and high-temperature condition, and which is excellent in the long-term cycle property. The present exemplary embodiment is a non-aqueous secondary battery including an electrolyte liquid including a supporting salt and a non-aqueous electrolyte solvent, wherein the non-aqueous electrolyte solvent includes a sulfone compound represented by a predetermined formula and a fluorine-containing ester compound represented by a predetermined formula; a content of the sulfone compound in the non-aqueous electrolyte solvent is 20 vol % or more and 70 vol % or less; and a content of the fluorine-containing ester compound in the non-aqueous electrolyte solvent is 20 vol % or more and 60 vol % or less.

### TECHNICAL FIELD

The present invention relates to a non-aqueous secondary battery.

### BACKGROUND ART

In recent years, there have been actively progressed developments of lithium ion batteries for applications to driving power sources for two-wheeled vehicles and automobiles, and distributed power source systems in combination with primary batteries such as solar batteries and wind power generations in addition to power sources for small-size devices such as mobile phones and laptop computers.

These applications require not only a life property which enable long-term use, but also high safety in a broad-range temperature condition. Therefore, for electrolyte liquid formulations, which have an especially large impact on the long-term cycle and safety, studies on various materials and additives have been broadly made.

For electrolyte liquids for lithium ion batteries, carbonate-based non-aqueous solvents are usually used. This is because carbonate-based non-aqueous solvents are excellent in electrochemical resistance and inexpensive. In almost every case, a mixed electrolyte liquid comprised of a cyclic carbonate such as ethylene carbonate (EC) or propylene carbonate (PC) together with a chain-type carbonate such as diethyl carbonate (DEC) or dimethyl carbonate (DMC). Cyclic carbonates, which have a high dielectric constant, have a function of dissolving/dissociating lithium salts such as LiPF₆; and chain-type carbonates, which have a low viscosity, have a function of improving diffusion of lithium ions in electrolyte liquids.

However, under the long-term cycle and high-temperature conditions, decomposition of an electrolyte liquid progresses with the deterioration of the electrode, and therefore a decrease in the capacity, the generation of gases and the like largely occurs to decrease cycle property and damage the safety in some cases. Particularly in lithium ion batteries using a high-voltage type positive electrode, to which attention has recently been paid as a way to generate higher capacity, these problems remarkably arise.

In order to prevent the decomposition of electrolyte liquids, Patent Literatures 1 to 3 study means to enhance the oxidation resistance at high voltage using a fluorine compound as an electrolyte liquid solvent.

Patent Literature 4 further discloses a non-aqueous electrolyte liquid containing a high-concentration fluorine-substituted carboxylate ester.

Patent Literature 5 further discloses a method in which together with a chain-type fluorine-substituted carboxylate ester, 4-fluoroethylene carbonate (FEC) is used as a film forming agent for the negative electrode.

### CITATION LIST

### Patent Literature

Patent Literature 1: JP06-20719A
Patent Literature 2: JP07-37613A
Patent Literature 3: JP4328915B
Patent Literature 4: JP3311611B
Patent Literature 5: JP2009-289414A

### SUMMARY OF INVENTION

### Technical Problem

Means disclosed in Patent Literatures 1 to 3 are technique using a chain-type fluorine-substituted carboxylate ester. However, since the fluorine-substituted carboxylate ester has a low dielectric constant and therefore cannot dissolve lithium salts such as LiPF₆ in single use, concurrent use of a carbonate-based solvent is essential. Therefore, in lithium ion batteries using a high-voltage positive electrode such as a 5-V class positive electrode, the decomposition of the carbonate-based solvent component progresses, there has been some cases where the effect cannot been sufficiently obtained.

Also in the means of Patent Literature 4, for the reason similar to the above, concurrent use of a high-dielectric constant solvent to dissolve lithium salts is essential. However, a fluorine-substituted carboxylate ester singly has poor compatibility with other non-aqueous solvents such as a carbonate-based solvent in many cases, and reduces the degree of dissolution and dissociation of lithium salts, which causes the viscosity of an electrolyte liquid to increase and lithium ion electroconductivity to decrease in some cases.

The means of Patent Literature 5, even in the case of containing a carbonate-based solvent component in the electrolyte liquid, can reduce the reductive decomposition of the carbonate-based solvent due to the effect of the film forming agent. However, the reductive decomposition of the electrolyte liquid cannot sufficiently be prevented in the oxidative decomposition on the positive electrode caused at a high voltage in some cases.

Then, the present exemplary embodiment has an object to provide a non-aqueous secondary battery in which the decomposition of an electrolyte liquid is effectively reduced even under high-voltage and high-temperature condition, and which is excellent in long-term cycle property.

### Solution to Problem

The present exemplary embodiment is:

a non-aqueous secondary battery comprising an electrolyte liquid comprising a supporting salt and a non-aqueous electrolyte solvent,

wherein the non-aqueous electrolyte solvent comprises a sulfone compound represented by the following formula (1) and a fluorine-containing ester compound represented by the following formula (A);

a content of the sulfone compound in the non-aqueous electrolyte solvent is 20 vol % or more and 70 vol % or less; and

a content of the fluorine-containing ester compound in the non-aqueous electrolyte solvent is 20 vol % or more and 60 vol % or less.

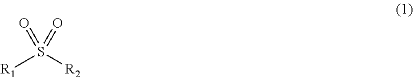

In the formula (1), R₁ and R₂ each independently denote a substituted or non-substituted alkyl group, and a carbon atom of R₁ and a carbon atom of R₂ may bond to each other through a single bond or a double bond to form a cyclic structure.

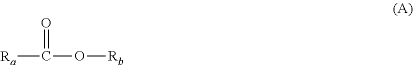

In the formula (A), Rₐ and R_{b} each independently denote an alkyl group or a fluorine-substituted alkyl group, and at least one of Rₐ and R_{b} is a fluorine-substituted alkyl group.

### Advantageous Effects of Invention

The present exemplary embodiment can provide a non-aqueous secondary battery in which the decomposition of an electrolyte liquid under high-voltage and high-temperature conditions is reduced, and which is excellent in the long-term cycle property.

### BRIEF DESCRIPTION OF DRAWING

FIG. 1 is a schematic cross-sectional view showing a structure of an electrode assembly of a stacked laminate-type secondary battery.

### DESCRIPTION OF EMBODIMENT

The mechanism of the advantageous effect of the present exemplary embodiment is assumed as follows. First, since a fluorine-containing ester compound whose oxidation resistant property is excellent has the adsorption action on an electrode of a lithium ion battery, a stable film is formed on the electrode surface. Then, since the film suppresses the decomposition of an electrolyte liquid, the long-term cycle property of the battery is improved. The action of a sulfone compound having compatibility with the fluorine-containing ester compound can also sufficiently dissolve/dissociate lithium salts, thus providing lithium ion conductivity at a practical level. Although the mechanism to reduce the decomposition of a sulfone compound in an electrolyte liquid is not clear at present, it is presumed that the relatively excellent oxidation resistance of a sulfone compound and the film formed from a fluorine-containing ester compound effectively and synergistically reduce the reductive decomposition. Here, these presumption does not limit the present invention.

Hereinafter, an exemplary embodiment of the lithium ion battery according to the present invention will be described.

[1]Electrolyte Liquid

A non-aqueous secondary battery in the present exemplary embodiment comprises an electrolyte liquid made by dissolving a supporting salt in a non-aqueous electrolyte solvent.

The non-aqueous electrolyte solvent in the present exemplary embodiment comprises at least a sulfone compound represented by the following formula (1) and a fluorine-containing ester compound represented by the following formula (A) as solvents. The content of the sulfone compound is 20 vol % or more and 70 vol % or less in the non-aqueous electrolyte solvent; and the content of the fluorine-containing ester compound is 20 vol % or more and 60 vol % or less in the non-aqueous electrolyte solvent.

As described above, a non-aqueous electrolyte solvent in the present exemplary embodiment comprises a sulfone compound represented by the following formula (1) as a solvent.

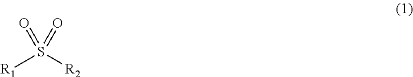

In the formula (1), R₁ and R₂ each independently denote a substituted or non-substituted alkyl group, and a carbon atom of R₁ and a carbon atom of R₂ may bond to each other through a single bond or a double bond to form a cyclic structure.

In R₁ and R₂, the alkyl group preferably has 1 to 12 carbon atoms, more preferably 1 to 8 carbon atoms, still more preferably 1 to 6 carbon atoms, and especially preferably 1 to 4 carbon atoms.

The alkyl group includes straight-chain type, branched-chain type and cyclic ones, but straight-chain type or branched-chain type ones are preferable.

In R₁ and R₂, examples of the substituent include alkyl groups having 1 to 6 carbon atoms (for example, a methyl group, an ethyl group, a propyl group, an isopropyl group, a butyl group and an isobutyl group), aryl groups having 6 to 10 carbon atoms (for example, a phenyl group and a naphthyl group), and halogen atoms (for example, a chlorine atom, a bromine atom and a fluorine atom).

A carbon atom of R₁ and a carbon atom of R₂ preferably bond to each other through a single bond to form a cyclic structure.

The sulfone compound is preferably a cyclic sulfone compound represented by the following formula (2).

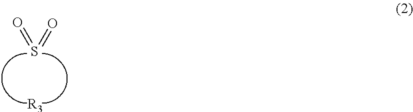

In the formula (2), R₃ denotes a substituted or non-substituted alkylene group.

In R₃, the alkylene group preferably has 4 to 16 carbon atoms, more preferably 4 to 14 carbon atoms, still more preferably 4 to 12 carbon atoms, and especially preferably 4 to 10 carbon atoms.

In R₃, examples of the substituent include alkyl groups having 1 to 6 carbon atoms (for example, a methyl group, an ethyl group, a propyl group, an isopropyl group and a butyl group), and halogen atoms (for example, a chlorine atom, a bromine atom and a fluorine atom).

The cyclic sulfone compound is more preferably a compound represented by the following formula (3).

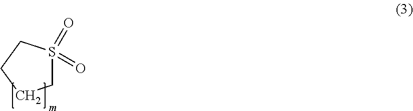

In the formula (3), m is an integer of 1 to 10.

In the formula (3), m is preferably an integer of 1 to 8, more preferably an integer of 1 to 6, still more preferably an integer of 1 to 4, and especially preferably an integer of 1 to 3.

Examples of the cyclic sulfone compound represented by the formula (3) preferably include tetramethylene sulfone, pentamethylene sulfone and hexamethylene sulfone. Since these materials are compatible with a fluorine-containing ester compound and simultaneously have a relatively high dielectric constant, they have an advantage of being excellent in the dissolution/dissociation action of lithium salts.

A cyclic sulfone compound having a substituent preferably includes 3-methyl sulfolane, 2,4-dimethyl sulfolane or the like. Since these materials are compatible with a fluorine-containing ester compound and simultaneously have a relatively high dielectric constant, they have an advantage of being excellent in the dissolution/dissociation action of lithium salts.

A sulfone compound may be a chain-type sulfone compound, and examples of the chain-type sulfone compound include ethyl methyl sulfone, ethyl isopropyl sulfone, ethyl isobutyl sulfone, dimethyl sulfone, diethyl sulfone or the like. Among these, ethyl methyl sulfone, ethyl isopropyl sulfone and ethyl isobutyl sulfone are preferable. Since these materials are compatible with a fluorine-containing ester compound and simultaneously have a relatively high dielectric constant, they have an advantage of being excellent in the dissolution/dissociation action of lithium salts.

The sulfone compound can be used alone or as a mixture of two or more. A non-aqueous electrolyte solvent in the present exemplary embodiment can comprise at least one sulfone compound selected from compounds represented by the formula (1).

The content of a sulfone compound is 20 vol % or more and 70 vol % or less in a non-aqueous electrolyte solvent. In the case of setting the content of a sulfone compound to be 20 vol % or more, lithium salts can be sufficiently dissolved by the action of the sulfone compound that is compatible with a fluorine-containing ester compound, thus providing a lithium ion conductivity of a practical level. In the case of setting the content of a sulfone compound to be 70 vol % or less, an excessive increase in the viscosity of an electrolyte liquid can be suppressed. From these viewpoints, the content of a sulfone compound is preferably 23 vol % or more and 60 vol % or less, and more preferably 25 vol % or more and 50 vol % or less, in a non-aqueous electrolyte solvent.

A non-aqueous electrolyte solvent in the present exemplary embodiment comprises a fluorine-containing ester compound represented by the following formula (A) as a solvent. The fluorine-substituted ester compound has advantages of being excellent in oxidation resistance and having a relatively low viscosity. Therefore, the fluorine-substituted ester compound can prevent the oxidative decomposition at a high voltage, and also has only a small influence on the lithium ion conductivity and the electrolyte liquid property.

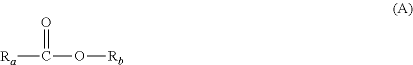

In the formula (A), Rₐ and R_{b} each independently denote an alkyl group or a fluorine-substituted alkyl group, and at least one of Rₐ and R_{b} is a fluorine-substituted alkyl group.

In the formula (A), in Rₐ and R_{b}, the alkyl group or the fluorine-substituted alkyl group preferably has 1 to 12 carbon atoms, more preferably 1 to 8 carbon atoms, still more preferably 1 to 6 carbon atoms, and especially preferably 1 to 4 carbon atoms.

The fluorine-substituted alkyl group refers to a substituted alkyl group having a structure in which at least one hydrogen atom of a non-substituted alkyl group is substituted with a fluorine atom. The alkyl group includes straight-chain type, branched-chain type and cyclic ones, but the fluorine-substituted alkyl group is preferably a straight-chain type one.

In the formula (A), for example, Rₐ and R_{b} are each independently a fluorine-substituted alkyl group. Further in the formula (A), for example, Rₐ is an alkyl group, and R_{b} is a fluorine-substituted alkyl group. Further in the formula (A), for example, Rₐ is a fluorine-substituted alkyl group, and R_{b} is an alkyl group.

In the formula (A), preferably, one of Rₐ and R_{b} is an alkyl group and the other is a fluorine-substituted alkyl group. A fluorine-containing ester compound having such a structure has excellent oxidation resistance property and simultaneously has good compatibility with other solvents.

Further in the formula (A), more preferably, Rₐ is a fluorine-substituted alkyl group and R_{b} is an alkyl group; and the fluorine-containing ester compound is more preferably, for example, a compound represented by the following formula (B).

R¹—COO—R² (B)

In the formula (B), R¹ denotes —CₙH₂ₙ₊₁₋ₘFₘ, n is an integer of 1 to 3, and m is an integer of 1 or more and 2n+1 or less; and R² denotes —C₁H₂₁₊₁, and 1 is an integer of 1 to 3.

The fluorine-containing ester compound is more preferably a compound represented by the following formula (C) or (D).

R³—R⁴‘3COO‘3R⁵ (C)

In the formula (C), R³ denotes —CH₃₋ₘFₘ, and m is 1,2 or 3; R⁴ denotes —CH₂₋ₙFₙ—, and n is 0, 1 or 2; and R⁵ is —CH₃, —C₂H₅ or —C₃H₇.

R⁶—R⁷—CH₂—COO—R⁸ (D)

In the formula (D), R⁶ denotes —CH₃₋ₘFₘ, and m is 1,2 or 3; R⁷ denotes —CH₂₋ₙFₙ—, and n is 0, 1 or 2; and R⁸ is —CH₃, —C₂H₅ or —C₃H₇.

A fluorine-containing ester compound is preferably methyl 2,2,3,3-tetrafluoropropionate or ethyl 2,2,3,3-tetrafluoropropionate. In addition to having good oxidation resistance property, the advantages of these compounds include good practical properties including viscosity, boiling point, melting point and flashing point.

Examples of compounds preferably used as the fluorine-containing ester compound are shown in Table 1.

TABLE 1

| Abbreviated | | Molecular | Molecular |
|---|---|---|---|
| name | Name | Structure | Formula |
| TFMP | METHYL 2,2,3,3- TETRA- FLUORO- PROPIONATE | 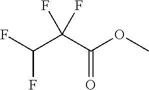 | C4H4F4O2 |
| TFMFMP | METHYL 2- (TRIFLUORO- METHYL)- 3,3,3- TRIFLUORO- PROPIONATE | 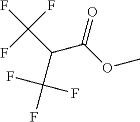 | C5H4F6O2 |
| FEP | ETHYL 3,3,3- TRIFLUORO- PROPIONATE | 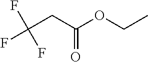 | C5H7F3O2 |
| FEA | 2,2,2-TRI- FLUORO- ETHANOL ACETATE | 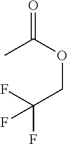 | C4H5F3O2 |
| FMP | METHYL 3,3,3- TRIFLUORO- PROPIONATE | 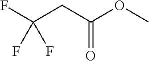 | C4H5F3O2 |

A fluorine-containing ester compound can be used alone or as a mixture of two or more. A non-aqueous electrolyte solvent in the present exemplary embodiment can comprise at least one fluorine-containing ester compound selected from compounds represented by the formula (A)

The content of a fluorine-containing ester compound is 20 vol % or more and 60 vol % or less in a non-aqueous electrolyte solvent. When the content of a fluorine-containing ester compound is 20 vol % or more, it is possible to effectively form a film on the negative electrode surface, and thereby more effectively suppress the decomposition of an electrolyte liquid. When the content of a fluorine-containing ester compound is 60 vol % or less, it is possible to sufficiently secure the dissolution/dissociation of lithium salts such as LiPF₆ and the compatibility with other solvents. From these viewpoints, the content of a fluorine-containing ester compound is preferably 25 vol % or more and 55 vol % or less, and more preferably 30 vol % or more and 50 vol % or less in a non-aqueous electrolyte solvent.

A non-aqueous electrolyte solvent can comprise propylene carbonate (PC). PC is known to generally have reactivity with a crystalline graphite negative electrode and to be thereby liable to be decomposed. However, in the present exemplary embodiment, the effect of a film formed from a fluorine-containing ester compound on a negative electrode enables to effectively suppress the decomposition of PC on the graphite and also to effectively provide features of the oxidation resistance and the low viscosity which PC intrinsically has. The content of propylene carbonate in a non-aqueous electrolyte solvent is preferably 10 vol % or more and 50 vol % or less, more preferably 15 vol % or more and 40 vol % or less, and still more preferably 20 vol % or more and 30 vol % or less.

A non-aqueous electrolyte solvent may further comprise other solvent components, and examples of the other solvent components that can be suitably used are carbonates, chlorinated hydrocarbons, ethers, ketones and nitriles. More specific examples of the other solvent components include ethylene carbonate (EC), propylene carbonate (PC), butylene carbonate (BC), γ-butyrolactone (GBL), diethyl carbonate (DEC), dimethyl carbonate (DMC) and ethyl methyl carbonate (EMC). Solvents which are obtained by substituting a part of functional groups of the above solvents with fluorine may be used.

A non-aqueous electrolyte solvent of the present exemplary embodiment can comprise a chain-type fluorine-containing ether compound represented by the following formula (I). Since the chain-type fluorine-containing ether compound has relatively high resistance to chemical reactivity with an acid, an alkali, moisture and the like, in addition to good oxidation resistance, the chain-type fluorine-containing ether compound improves the stability of an electrolyte liquid in a broader-range condition, in the case of being used concurrently with a fluorine-containing ester compound.

[Formula 7]

R_{a —O—R}_{b} (I)

In the formula (I), Rₐ and R_{b} each independently denote an alkyl group or a fluorine-substituted alkyl group, and at least one of Rₐ and R_{b} is a fluorine-substituted alkyl group.

In Rₐ and R_{b}, the alkyl group preferably has 1 to 12 carbon atoms, more preferably 1 to 8 carbon atoms, still more preferably 1 to 6 carbon atoms, and especially preferably 1 to 4 carbon atoms. In the formula (I), the alkyl group includes straight-chain type, branched-chain type and cyclic ones, but a straight-chain type one is preferable.

At least one of Rₐ and R_{b} is a fluorine-substituted alkyl group. The fluorine-substituted alkyl group refers to a substituted alkyl group having a structure in which at least one hydrogen atom of a non-substituted alkyl group is substituted with a fluorine atom. A fluorine-substituted alkyl group is preferably a straight-chain type one. Rₐ and R_{b} are each independently a fluorine-substituted alkyl group preferably having 1 to 6 carbon atoms, and more preferably having 1 to 4 carbon atoms.

A chain-type fluorine-containing ether compound is preferably a compound represented by the following formula (II) from the viewpoint of the voltage resistance and the compatibility with other solvents.

Y¹—(CY²Y³)ₙ—CH₂O—CY⁴Y⁵—CY⁶Y⁷—Y⁸ (II)

In the formula (II), n is 1 to 8, and Y¹ to Y⁸ are each independently a fluorine atom or a hydrogen atom, provided that at least one of Y¹ to Y³ is a fluorine atom, and that at least one of Y⁴ to Y⁸ is a fluorine atom.

In the formula (II), Y² and Y³ may be each independent for every n.

A chain-type fluorine-containing ether compound is more preferably a compound represented by the following formula (III) from the viewpoint of the viscosity of an electrolyte liquid and the compatibility with other solvents.

H—(CX¹X²—CX³X⁴)ₙ—CH₂O—CH⁵X⁶—CX⁷X⁸—H (III)

In the formula (III), n is 1, 2, 3 or 4. X¹ to X⁸ are each independently a fluorine atom or a hydrogen atom, provided that at least one of X¹ to X⁴ is a fluorine atom, and that at least one of X⁵ to X⁸ is a fluorine atom. X¹ to X⁴ may be each independent for every n.

In the formula (III), n is preferably 1 or 2, and more preferably 1.

Further in the formula (III), the atomic ratio of a fluorine atom to a hydrogen atom [(a total number of a fluorine atom)/(a total number of a hydrogen atom)] is preferably 1 or more.

Examples of the chain-type fluorine-containing ether compound include CF₃OCH₃, CF₃OC₂H₆, F(CF₂)₂OCH₃, F(CF₂)₂OC₂H₅, F(CF₂)₃OCH₃, F(CF₂)₃OC₂H₅, F(CF₂)₄OCH₃, F(CF₂)₄OC₂H₅, F(CF₂)₅OCH₃, F(CF₂)₅OC₂H₅, F(CF₂)₈OCH₃, F(CF₂)₈OC₂H₅, F(CF₂)₉OCH₃, CF₃CH₂OCH₃, CF₃CH₂OCHF₂, CF₃CF₂CH₂OCH₃, CF₃CF₂CH₂OCHF₂, CF₃CF₂CH₂O(CF₂)₂H, CF₃CF₂CH₂O(CF₂)₂F, HCF₂CH₂OCH₃, H(CF₂)₂OCH₂CH₃, H(CF₂)₂OCH₂CF₃, H(CF₂)₂CH₂OCHF₂, H(CF₂)₂CH₂O(CF₂)₂H, H(CF₂)₂CH₂O(CF₂)₃H, H(CF₂)₃CH₂O(CF₂)₂H, (CF₃)₂CHOCH₃, (CF₃)₂CHCF₂OCH₃, CF₃CHFCF₂OCH₃, CF₃CHFCF₂OCH₂CH₃, CF₃CHFCF₂CH₂OCHF₂.

The content of a chain-type fluorine-containing ether compound in an electrolyte liquid is, for example, 5 to 30 mass %. The content of a chain-type fluorine-containing ether compound in an electrolyte liquid is preferably 5 to 25 mass %, more preferably 7 to 20 mass %, and still more preferably 10 to 15 mass %.

The content of a chain-type fluorine-containing ether compound in a non-aqueous electrolyte solvent is, for example, 5 vol % or more and 30 vol % or less. The content of a chain-type fluorine-containing ether compound in a non-aqueous electrolyte solvent is preferably 5 vol % or more and 25 vol % or less, more preferably 7 vol % or more and 20 vol % or less, and still more preferably 10 vol % or more and 15 vol % or less.

A supporting salt used in the present exemplary embodiment is, for example, a lithium salt. Examples of the lithium salt include LiPF₆, LiAsF₆, LiAlCl₄, LiClO₄, LiBF₄, LiSbF₆, LiCF₃SO₃, LiC₄F₉CO₃, LiC(CF₃SO₂)₂, LiN(CF₃SO₂)₂, LiN(C₂F₅SO₂)₂, LiB₁₀Cl₁₀, lithium lower aliphatic carboxylates, chloroborane lithium, lithium tetraphenylborate, LiCl, LiBr, LiI, LiSCN, LiCl and lithium imide salts. The concentration of a lithium salt in an electrolyte liquid is, for example, 0.5 mol/l to 1.5 mol/l. When the concentration is in this range, it is possible to make an electrolyte liquid having a reasonable density, viscosity and electroconductivity. The composition of an electrolyte liquid and the concentration of a lithium salt may be suitably selected and regulated in consideration of the environment for use of a battery, the optimization of the battery to its application, and the like.

In the present exemplary embodiment, an electrolyte liquid is not limited to a liquid type, and may be a gel type. For example, an electrolyte liquid is contained in a polymer electrolyte, and the polymer electrolyte is disposed in a secondary battery in a state that the polymer swells with the electrolyte liquid. A polymer electrolyte is superior in suppressing the liquid leakage and gas generation.

An electrolyte liquid can comprise various types of additives. Examples of the additives include aliphatic carboxylate esters such as methyl formate, methyl acetate and ethyl propionate, γ-lactones such as γ-butyrolactone, chain ethers such as 1,2-ethoxyethane (DEE) and ethoxymethoxyethane (EME), cyclic ethers such as tetrahydrofuran and 2-methyltetrahydrofuran, dimethyl sulfoxide, 1,3-dioxolane, formamide, acetamide, dimethylformamide, dioxolane, acetonitrile, propylnitrile, nitromethane, ethyl monoglyme, phosphorate triesters, trimethoxymethane, dioxolane derivatives, sulfolane, methyl sulfolane, 1,3-dimethyl-2-imidazolidinone, 3-methyl-2-oxazolidinone, propylene carbonate derivatives, tetrahydrofuran derivatives, ethyl ether, 1,3-propanesultone, anisole and N-methylpyrrolidone.

The amount of a non-aqueous electrolyte solvent is not especially limited, and can be suitably selected as long as it exhibits the advantageous effect of the present exemplary embodiment. The amount of a non-aqueous electrolyte solvent based on 100 parts by mass of an electrolyte liquid is, for example, 80 parts by mass or more, preferably 85 parts by mass or more, more preferably 90 parts by mass or more, still more preferably 95 parts by mass or more, and especially preferably 98 parts by mass or more.

[2] Positive Electrode

In the present exemplary embodiment, a positive electrode active substance is not especially limited as long as it can intercalate lithium ions in the charging time and disintercalate lithium ions in the discharging time, and for example, a known positive electrode active substance can be used. However, by selecting a lithium manganese composite oxide as a positive electrode active substance, the advantageous effect of the present exemplary embodiment can be attained more effectively. The lithium manganese composite oxide is known to cause elution of a manganese component by the reaction with an electrolyte liquid and thereby deteriorate the battery property. However, since unnecessary reactions between a positive electrode and the electrolyte liquid are suppressed in the present exemplary embodiment, the advantageous effect can be attained more remarkably.

A lithium transition metal oxide is not especially limited, but examples thereof include lithium manganate having a layer structure and lithium manganate having a spinel structure, such as LiMnO₂ and LiₓMn₂O₄ (0<x<2); LiCoO₂, LiNiO₂, and those obtained by substituting a part of transition metal of LiCoO₂ or LiNiO₂ is substituted with other metals; lithium transition metal oxides whose specific transition metals do not exceed a half, such as LiNi_{1/3}Co_{1/3}Mn_{1/3}O₂; those having an olivine structure, such as LiFePO₄; and those obtained by making Li amount of these lithium transition metal oxides to be larger than the stoichiometric composition. In Particular, Li_{α}Ni_{β}Co_{γ}Al_{δ}O₂ (1≦α≦1.2, β+γ+δ=1, β≧0.7, γ≦0.2) or Li_{α}Ni_{β}Co_{γ}Mn_{δ}O₂ (1≦α≦1.2, β+γ+δ=1, β≧0.6, γ≦0.2) are preferable. These materials can be used alone or in a combination of two or more.

A lithium manganese composite oxide usable in the present exemplary embodiment is, for example, a so-called 4-V class manganese spinel represented by the following formula.

LiₓMn₂O₄ (here, 1.02≦x≦1.08) (Formula 1)

A lithium manganese composite oxide is preferably one capable of occluding and releasing lithium at 4.5 V or higher vs. a metal lithium counter electrode potential; and a lithium-containing composite oxide having a plateau at 4.5 V or higher vs. a metal lithium counter electrode potential is more preferably used. Such a lithium-containing composite oxide includes spinel-type lithium manganese composite oxides, olivine-type lithium manganese-containing composite oxides and inverse spinel-type lithium manganese-containing composite oxides. The lithium-containing composite oxide specifically includes compounds represented by Liₐ(MₓMn₂₋ₓ)O₄ (wherein, 0<x<2; 0<a<1.2; and M is at least one metal selected from the 3 0 group consisting of Ni, Co, Fe, Cr and Cu). Among these, spinel-type lithium manganese composite oxides are preferable from the viewpoint of the safety.

As a lithium manganese composite oxide having a plateau at 4.5 V or higher, a so-called 5-V class manganese spinel represented by the following formula is preferably used.

Liₐ(M_{b}Mn_{2-b-c}A_{c})O₄ (Formula 2)

In the formula, 0.8<a<1.2, 0.4<b <0.6, and 0≦c≦0.3; M is at least one metal selected from Ni, Co, Fe, Cr and Cu, and comprises at least Ni; and A is at least one metal selected from Si, Ti, Mg and Al.

Among the above-mentioned lithium manganese composite oxides, in particular, a 5-V class manganese spinel is preferably used. In the case of using the 5-V class manganese spinel, the advantageous effect of the present exemplary embodiment can be more exhibited by the effect of suppressing the decomposition of an electrolyte liquid at a high voltage.

A positive electrode binder is not especially limited, but usable are, for example, polyvinylidene fluoride, vinylidene fluoride-hexafluoropropylene copolymers, vinylidene fluoride-tetrafluoroethylene copolymers, styrene-butadiene copolymer rubber, polytetrafluoroethylene, polypropylene, polyethylene, polyimide and polyamidoimide. Among these, polyvinylidene fluoride is preferable from the viewpoint of versatility and low cost. The use amount of a positive electrode binder is preferably 2 to 10 parts by mass per 100 parts by mass of a positive electrode active substance from the viewpoint of “sufficient binding power” and “making the energy high”, which are in a tradeoff relation.

A positive electrode current collector is preferably nickel, copper, silver, aluminum or an alloy thereof from the viewpoint of the electrochemical stability. The shape includes foils, flat plate-shapes and mesh-shapes. In particular, a copper foil and an aluminum foil are preferable.

An electroconductivity auxiliary material may be added to a positive electrode active substance layer containing a positive electrode active substance in order to decrease the impedance. The electroconductivity auxiliary material includes carbonaceous fine particles of graphite, carbon black, acetylene black, and the like.

A positive electrode can be fabricated, for example, by mixing a lithium manganese composite oxide, an electroconductivity-imparting agent and a positive electrode binder to prepare a positive electrode slurry, and forming the positive electrode slurry on a positive electrode current collector.

An electroconductivity-imparting agent usable is, in addition to a carbon material, a powder of a metal substance such as Al, an electroconductive oxide or the like. A binder usable is a resin binder of polyvinylidene fluoride or the like. A current collector usable is a metal thin film mainly composed of Al or the like.

[3] Negative Electrode

A negative electrode active substance in the present exemplary embodiment is not especially limited as long as being capable of intercalating lithium ions in the charging time and disintercalating lithium ions in the discharging time, and for example, a known one can be used.

Specific examples of the negative electrode active substance include carbon materials such as graphite, coke and hard carbon, lithium alloys such as lithium-aluminum alloys, lithium-lead alloys and lithium-tin alloys, lithium metal, Si, and metal oxides less noble in potential than lithium manganese composite oxide substances, such as SnO₂, SnO, TiO₂, Nb₂O₃ and SiO. Among these materials, use of graphite more exhibits the advantageous effect of the present exemplary embodiment. In many cases of using graphite as a negative electrode, the reactivity with a non-aqueous electrolyte liquid is higher than in use of other materials, and the decomposition of an electrolyte liquid is more liable to be caused because of its potential property and surface chemical property. Since unnecessary reactions between the negative electrode and the electrolyte liquid can be prevented in the present exemplary embodiment, the advantageous effect of the present exemplary embodiment is more exhibited.

A negative electrode can be fabricated, for example, by forming a negative electrode active substance layer containing a negative electrode active substance and a negative electrode binder on a negative electrode current collector. Examples of a method for forming a negative electrode active substance layer include a doctor blade method, a die coater method, a CVD method and a sputtering method. A negative electrode current collector may be made by forming a thin film of aluminum, nickel or an alloy thereof by a method such as vapor deposition or sputtering after a negative electrode active substance layer is previously formed.

The negative electrode active substance layer may comprise an electroconductivity auxiliary agent such as carbon from the viewpoint of improving the electroconductivity.

A negative electrode binder is not especially limited, but usable are, for example, polyvinylidene fluoride, vinylidene fluoride-hexafluoropropylene copolymers, vinylidene fluoride-tetrafluoroethylene copolymers, styrene-butadiene copolymer rubber, polytetrafluoroethylene, polypropylene, polyethylene, polyimide and polyamidoimide. Among these, polyimide or polyamideimide are preferable because of strong bindability. The use amount of a negative electrode binder is preferably 7 to 20 parts by mass per 100 parts by mass of a negative electrode active substance from the viewpoint of “sufficient binding power” and “making the energy high”, which are in a tradeoff relation.

A negative electrode current collector is preferably nickel, copper, silver, aluminum or an alloy thereof from the viewpoint of the electrochemical stability. The shape includes foils, flat plate-shapes and mesh-shapes. In particular, a copper foil is preferable.

[4] Separator

A separator is not especially limited, but usable are, for example, polyolefin-based microporous membranes of polyethylene, polypropylene or the like, cellulose membranes, and the like.

[b 5] Package

A package is arbitrarily selected as long as it is stable against a battery electrolyte liquid and it has a sufficient water vapor barrier property. Examples of the shape of the package include cylindrical shapes, rectangular shapes (can shapes) and flat plate shapes. The package preferably has a flat plate shape using a laminate film.

A flat plate-shape secondary battery using a laminate film as a package is excellent for heat dissipation. Therefore, it is excellent for providing a large capacity secondary battery inputting and outputting a large energy. For example, in the case of a laminate-type secondary battery, a package usable is an aluminum laminate film, a SUS laminate film, or a laminate film of polypropylene, polyethylene or the like coated with silica. In particular, an aluminum laminate film is preferably used from the viewpoint of suppressing the volume expansion and the viewpoint of the cost.

[6] Secondary Battery

The constitution of a secondary battery according to the present exemplary embodiment is not especially limited, and can be, for example, a constitution such as an electrode assembly in which positive electrodes and negative electrodes are oppositely disposed, and an electrolyte liquid are contained in a package. The shape of the secondary battery is not especially limited, but includes, for example, a cylindrical shape, a flat wound rectangular shape, a stacked rectangular shape, a coin shape, a flat wound laminate shape, and a stacked laminate shape.

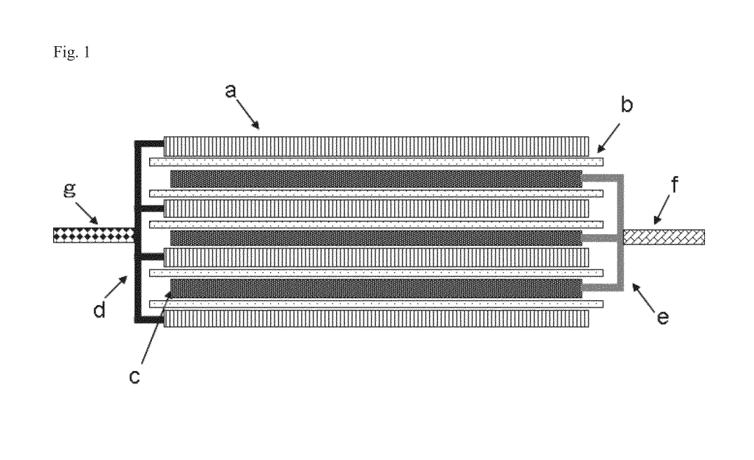

Hereinafter, a secondary battery of a stacked laminate type as an example will be described. FIG. 1 is a schematic cross-sectional view showing a structure of an electrode assembly of a stacked laminate-type secondary battery using a laminate film as a package. The electrode assembly is formed by alternately stacking a plurality of positive electrodes c and a plurality of negative electrodes a with a separator b interposed therebetween. Each positive electrode current collector e of the each positive electrode c is welded and electrically connected to each other at the end that is not covered with a positive electrode active substance of the positive electrode current collector e; and a positive electrode terminal f is further welded to the welded and connected portion. Each negative electrode current collector d of the each negative electrode a is welded and electrically connected to each other at the end that is not covered with a negative electrode active substance of the negative electrode current collector d; and a negative electrode terminal g is further welded to the welded and connected portion.

An electrode assembly having such a planar stacked structure has an advantage of being hardly adversely affected by the volume change of the electrodes involved in charging and discharging, over electrode assemblies having a winding structure, because of having no portions having small radius of curvature R (a region near a winding core of the winding structure, a folding region of a flat-type winding structure, and the like).

### EXAMPLE 1

The present Example used a lithium manganese composite oxide (LiNi_{0.5}Mn_{1.37}Ti_{0.13}O₄, hereinafter, referred to as 5-V class manganese spinel) as a positive electrode active substance. A graphite particle was used as a negative electrode active substance. A lithium ion battery cell was fabricated by using an electrolyte liquid of a composition shown in Table 2 and by the following procedure.

Hereinafter, the present Example will be described in detail.

<Positive Electrode>

The 5-V class manganese spinel and an electroconductivity-imparting agent (carbon black) were dry mixed to thereby obtain a mixture; and the mixture was homogeneously dispersed in N-methyl-2-pyrrolidone (NMP) in which a polyvinylidene fluoride (PVDF) as a binder was dissolved to thereby prepare a positive electrode slurry. Then, the positive electrode slurry was applied on an aluminum metal foil (thickness: 20 μm) as a positive electrode current collector, and thereafter, NMP was evaporated to thereby fabricate a positive electrode of 70 μm in film thickness. The solid content ratio in the positive electrode active substance layer, the active substance : the electroconductivity-imparting agent : PVDF, was set to be 91:5:4 (mass %).

<Negative Electrode>

For a negative electrode, materials were mixed so that the solid content ratio in a negative electrode active substance layer, the graphite : PVDF, was set to be 94:6 (mass %), to thereby obtain a mixture, and the mixture was homogeneously dispersed in NMP in which PVDF as a binder was dissolved to thereby prepare a negative electrode slurry. Then, the negative electrode slurry was applied on a copper foil (thickness: 10 μm) as a negative electrode current collector, and thereafter, NMP was evaporated to thereby fabricate a negative electrode of 50 μm in film thickness.

<Electrode Assembly>

The obtained positive electrode was cut into a shape having the positive electrode active substance layer of 28 mm×13 mm and the current collector having an extended part thereof of 5 mm×5 mm on the left short-side part of the layer. The negative electrode was also cut into a shape having the negative electrode active substance layer of 30 mm×14 mm and the current collector having an extended part thereof of 5 mm×5 mm on the right short-side part of the layer. The cut-out positive electrodes and negative electrodes were stacked through separators. Then, an aluminum tab of 5 mm wide, 20 mm long and 0 1 mm thick with a sealant was connected to the positive electrode current collectors, and a nickel tab of the same size with a sealant was connected to the negative electrode current collectors. Here, the tabs and the current collectors were ultrasonically welded to be thereby unified, respectively.

<Electrolyte Liquid>

A tetramethylene sulfone aqueous solvent as a sulfone compound and methyl 2,2,3,3-tetrafluoropropionate as a fluorine-containing ester compound were mixed in 50:50 (in volume ratio) to thereby prepare a non-aqueous electrolyte solvent. LiPF₆ as a supporting salt was mixed with the non-aqueous electrolyte solvent so that the concentration became 1 M to thereby obtain an electrolyte liquid.

### <Secondary Battery>

Then, an aluminum laminate film, composed of a polypropylene and an aluminum foil, of 125 μm thick and 70 mm×70 mm as a package was folded into two, and the electrode assembly was inserted into the package. Then, sides excluding one side of the aluminum laminate through which the electrolyte liquid was injected were sealed by thermal fusion. Thereafter, the electrolyte liquid was injected and impregnated under reduced pressure, and then, the open part was sealed under vacuum to thereby fabricate a stacked laminate-type lithium ion secondary battery.

(Evaluation of the Charge and Discharge Property)

Charge and discharge cycle property of the fabricated secondary battery were evaluated in a high-temperature condition. The charge and discharge condition was set at a temperature of 45° C., at a charge rate of 1.0 C, at a discharge rate of 1.0 C, at a charge end voltage of 4.75 V and at a discharge end voltage of 3.0 V. The capacity maintenance rates after cycles are shown in Table 2.

The “capacity maintenance rate (%)” was calculated based on the expression: (a discharge capacity after 50 cycles or 100 cycles)/(a discharge capacity after 5 cycles)×100 (unit: %).

(Evaluation of Gas Generation)

The amount of gases generated was evaluated by measuring the change in cell volume after a charge and discharge cycle. The cell volume was measured using the Archimedes method, and the amount of gases generated was calculated by examining the difference in cell volume before and after the charge and discharge cycle. The amounts of gases generated after the each cycles are shown in Table 2.

The results of Table 2 reveal that, as compared to Comparative Examples, in the case of the secondary battery (Example 1) that uses a non-aqueous electrolyte solvent comprising a fluorine-containing ester compound and a sulfone compound, the capacity maintenance rate after the charge and discharge was high and also the gas generation amount was reduced to a half or less.

Also in the case of a secondary battery (Example 2) that uses a non-aqueous electrolyte solvent in which a part of SL of the non-aqueous electrolyte solvent of Example 1 was replaced by PC, as compared to Comparative Examples, the capacity maintenance rate after the charge and discharge was high and also the gas generation amount was reduced to a half or less.

TABLE 2

| | Non-Aqueous Electrolyte Solvent | | | | | | | |
|---|---|---|---|---|---|---|---|---|
| | | Fluorine- | | | 50 Cycles | | 100 Cycles | |
| | | Containing | | | Capacity | Gas | Capacity | Gas |
| | Sulfone | Ester | Carbonate | Compositional | Maintenance | Generation | Maintenance | Generation |
| | Compound (A) | Compound (B) | Compound (C) | Ratio (A:B:C) | Rate (%) | Amount (cc) | Rate (%) | Amount (cc) |
| Example 1 | SL | TFMP | — | 50:50:0 | 99 | 0.20 | 95 | 0.31 |
| Example 2 | SL | TFMP | PC | 25:50:25 | 99 | 0.18 | 92 | 0.35 |
| Comparative | — | — | EC/DMC | 0:0:100 | 89 | 0.65 | 76 | 0.84 |
| Example 1 | | | (4/6) | | | | | |
| Comparative | — | — | PC/DMC | 0:0:100 | — | — | — | — |
| Example 2 | | | (4/6) | | | | | |
| Comparative | SL | — | DMC | 40:0:60 | 1 | 7.05 | <1 | — |
| Example 3 | | | | | | | | |
| Comparative | — | TFMP | PC | 0:50:50 | 90 | 0.29 | 75 | 0.50 |
| Example 3 | | | | | | | | |
| Comparative | — | TFMP | PEC | 0:50:50 | 85 | 1.03 | 75 | 1.83 |
| Example 4 | | | | | | | | |

* The compositional ratio is described in terms of volume.
SL: tetramethylene sulfone
PC: propylene carbonate
EC: ethylene carbonate
FEC: 4-fluoroethylene carbonate
DMC: dimethyl carbonate

The present application claims the priority based on Japanese Patent Application No. 2011-204597, filed on Sep. 20, 2011, the entire of the disclosure of which is hereby incorporated by reference.

Hitherto, the present invention has been described with reference to the exemplary embodiment and the Examples, but the present invention is not limited to the exemplary embodiment and the Examples. The constitution and the detail of the present invention may be subjected to various changes understandable for those skilled in the art without departing from the scope of the present invention.

(Additional Statement 1)

A non-aqueous secondary battery having an electrolyte liquid comprising a supporting salt and a non-aqueous electrolyte solvent,

wherein the non-aqueous electrolyte solvent comprises a sulfone compound represented by the following formula (1) and a fluorine-containing ester compound represented by the following formula (A);

a content of the sulfone compound in the non-aqueous electrolyte solvent is 20 vol % or more and 70 vol % or less; and

a content of the fluorine-containing ester compound in the non-aqueous electrolyte solvent is 20 vol % or more and 60 vol % or less.

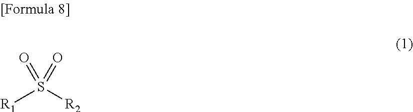

In the formula (1), R₁ and R₂ each independently denote a substituted or non-substituted alkyl group, and a carbon atom of R₁ and a carbon atom of R₂ may bond to each other through a single bond or a double bond to form a cyclic structure.

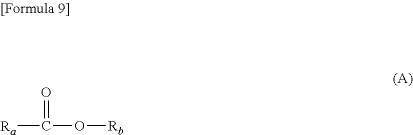

In the formula (A), Rₐ and R_{b} each independently denote an alkyl group or a fluorine-substituted alkyl group, and at least one of Rₐ and R_{b} is a fluorine-substituted alkyl group.

(Additional Statement 2)

The non-aqueous secondary battery according to claim 1, wherein the sulfone compound is a cyclic sulfone compound represented by the following formula (2).

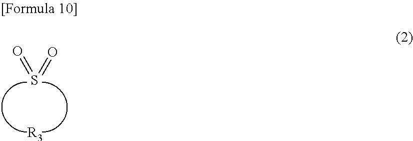

In the formula (2), R₃ denotes a substituted or non-substituted alkylene group.

(Additional Statement 3)

The non-aqueous secondary battery according to claim 2, wherein the cyclic sulfone compound is a compound represented by the following formula (3).

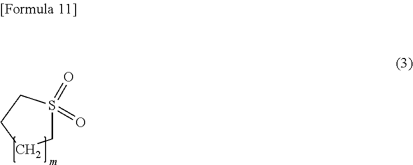

In the formula (3), m is an integer of 1 to 10.

(Additional Statement 4)

The non-aqueous secondary battery according to claim 3, wherein the cyclic sulfone compound is tetramethylene sulfone, pentamethylene sulfone or hexamethylene sulfone.

(Additional Statement 5)

The non-aqueous secondary battery according to claim 1, wherein the sulfone compound is ethyl methyl sulfone.

(Additional Statement 6)

The non-aqueous secondary battery according to any one of claims 1 to 5, wherein in the formula (A), either one of Rₐ and R_{b} is an alkyl group, and the other is a fluorine-substituted alkyl group.

(Additional Statement 7)

The non-aqueous secondary battery according to any one of claims 1 to 6, wherein the fluorine-containing ester compound is a compound represented by the following formula (B):

R¹—COO—R² (B)

wherein, R¹ denotes —CₙH₂ₙ₊₁₋ₘFₘ, n is an integer of 1 to 3, and m is an integer of 1 or more and 2n+1 or less; and R² denotes —C₁H₂₁₊₁, and 1 is an integer of 1 to 3.

(Additional Statement 8)

The non-aqueous secondary battery according to claim 7, wherein the fluorine-containing ester compound is a compound represented by the following formula (C) or (D):

R³—R⁴—COO—R⁵ (C)

wherein, R³ denotes —CH₃₋ₘFₘ, and m is 1,2 or 3; R⁴ denotes —CH₂₋ₙFₙ—, and n is 0, 1 or 2; and R⁵ is —CH₃, —C₂H₅ or —C₃H₇;

R⁶—R⁷—CH₂—COO—R⁸ (D),

wherein, R⁶ denotes —CH₃₋ₘFₘ, and m is 1,2 or 3; R⁷ denotes —CH₂₋ₙFₙ—, and n is 0, 1 or 2; and R⁸ is —CH₃, —C₂H₅ or —C₃H₇.

(Additional Statement 9)

The non-aqueous secondary battery according to any one of claims 1 to 8, wherein the fluorine-containing ester compound is methyl 2,2,3,3-tetrafluoropropionate or ethyl 2,2,3,3-tetrafluoropropionate.

(Additional Statement 10)

The non-aqueous secondary battery according to any one of claims 1 to 9, wherein the non-aqueous electrolyte solvent comprises propylene carbonate, and a content of the propylene carbonate in the non-aqueous electrolyte solvent is 10 vol % or more and 50 vol % or less.

(Additional Statement 11)

The non-aqueous secondary battery according to claim 10, wherein the non-aqueous secondary battery comprises a negative electrode comprising a negative electrode active substance, and the negative electrode active substance is graphite.

(Additional Statement 12)

The non-aqueous secondary battery according to any one of claims 1 to 11, wherein the non-aqueous secondary battery comprises a positive electrode comprising a positive electrode active substance, and the positive electrode active substance is a lithium manganese composite oxide.

(Additional Statement 13)

The non-aqueous secondary battery according to claim 12, wherein the lithium manganese composite oxide is capable of occluding and releasing lithium at 4.5 V or higher vs. a metal lithium counter electrode potential.

1. A non-aqueous secondary battery comprising an electrolyte liquid comprising a supporting salt and a non-aqueous electrolyte solvent,
wherein the non-aqueous electrolyte solvent comprises a sulfone compound represented by the following formula (1) and a fluorine-containing ester compound represented by the following formula (A);
a content of the sulfone compound in the non-aqueous electrolyte solvent is 20 vol % or more and 70 vol % or less; and
a content of the fluorine-containing ester compound in the non-aqueous electrolyte solvent is 20 vol % or more and 60 vol % or less: 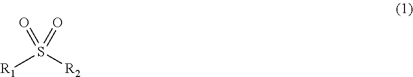
wherein, R₁ and R₂ each independently denote a substituted or non-substituted alkyl group, and a carbon atom of R₁ and a carbon atom of R₂ may bond to each other through a single bond or a double bond to form a cyclic structure; and 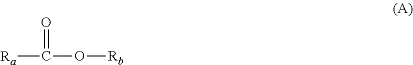
wherein, Rₐ and R_{b} each independently denote an alkyl group or a fluorine-substituted alkyl group, and at least one of Rₐ and R_{b} is a fluorine-substituted alkyl group.

2. The non-aqueous secondary battery according to claim 1, wherein the sulfone compound is a cyclic sulfone compound represented by the following formula (2): 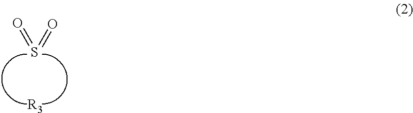
wherein, R₃ denotes a substituted or non-substituted alkylene group.

3. The non-aqueous secondary battery according to claim 2, wherein the cyclic sulfone compound is tetramethylene sulfone, pentamethylene sulfone, hexamethylene sulfone, 3-methyl sulfolane or 2,4-dimethyl sulfolane.

4. The non-aqueous secondary battery according to claim 1, wherein the fluorine-containing ester compound is a compound represented by the following formula (B):
R¹—COO—R² (B)
wherein, R¹ denotes —CₙH₂ₙ₊₁₋ₘFₘ, n is an integer of 1 to 3, and m is an integer of 1 or more and 2n+1 or less; and R² denotes —C₁H₂₁₊₁, and 1 is an integer of 1 to 3.

5. The non-aqueous secondary battery according to claim 4, wherein the fluorine-containing ester compound is a compound represented by the following formula (C) or (D):
R³—R⁴—COO—R⁵ (C)
wherein, R³ denotes —CH₃₋ₘFₘ, and m is 1,2 or 3; R⁴ denotes —CH₂₋ₙFₙ—, and n is 0, 1 or 2; and R⁵ is —CH₃, —C₂H₅ or —C₃H₇; and
R⁶—R⁷—CH₂—COO—R⁸ (D)
wherein, R⁶ denotes —CH₃₋ₘFₘ, and m is 1,2 or 3; R⁷ denotes —CH₂₋ₙFₙ—, and n is 0, 1 or 2; and R⁸ is —CH₃, —C₂H₅ or —C₃H₇.

6. The non-aqueous secondary battery according to claim 1, wherein the fluorine-containing ester compound is methyl 2,2,3,3-tetrafluoropropionate or ethyl 2,2,3,3-tetrafluoropropionate.

7. The non-aqueous secondary battery according to claim 1, wherein the non-aqueous electrolyte solvent comprises propylene carbonate, and a content of the propylene carbonate in the non-aqueous electrolyte solvent is 10 vol % or more and 50 vol % or less.

8. The non-aqueous secondary battery according to claim 7, wherein the non-aqueous secondary battery comprises a negative electrode comprising a negative electrode active substance, and the negative electrode active substance is graphite.

9. The non-aqueous secondary battery according to claim 1, wherein the non-aqueous secondary battery comprises a positive electrode comprising a positive electrode active substance, and the positive electrode active substance is a lithium manganese composite oxide.

10. The non-aqueous secondary battery according to claim 9, wherein the lithium manganese composite oxide is capable of occluding and releasing lithium at 4.5 V or higher vs. a metal lithium counter electrode potential.

11. The non-aqueous secondary battery according to claim 2, wherein the fluorine-containing ester compound is a compound represented by the following formula (B):
R¹—COO—R² (B)
wherein, R¹ denotes —CₙH₂ₙ₊₁₋ₘFₘ, n is an integer of 1 to 3, and m is an integer of 1 or more and 2n+1 or less; and R² denotes —C₁H₂₁₊₁, and 1 is an integer of 1 to 3.

12. The non-aqueous secondary battery according to claim 3, wherein the fluorine-containing ester compound is a compound represented by the following formula (B):
R¹—COO—R² (B)
wherein, R¹ denotes —CₙH₂ₙ₊₁₋ₘFₘ, n is an integer of 1 to 3, and m is an integer of 1 or more and 2n+1 or less; and R² denotes —C₁H₂₁₊₁, and 1 is an integer of 1 to 3.

13. The non-aqueous secondary battery according to claim 11, wherein the fluorine-containing ester compound is a compound represented by the following formula (C) or (D):
R³—R⁴‘3COO—R⁵ (C)
wherein, R³ denotes —CH₃₋ₘFₘ, and m is 1,2 or 3; R⁴ denotes —CH₂₋ₙFₙ—, and n is 0, 1 or 2; and R⁵ is —CH₃, —C₂H₅ or —C₃H₇; and
R⁶—R⁷—CH₂—COO—R⁸ (D)
wherein, R⁶ denotes —CH₃₋ₘFₘ, and m is 1,2 or 3; R⁷ denotes —CH₂₋ₙFₙ—, and n is 0, 1 or 2; and R⁸ is —CH₃, —C₂H₅ or —C₃H₇.

14. The non-aqueous secondary battery according to claim 12, wherein the fluorine-containing ester compound is a compound represented by the following formula (C) or (D):
R³—R⁴—COO—R⁵ (C)
wherein, R³ denotes —CH₃₋ₘFₘ, and m is 1,2 or 3; R⁴ denotes —CH₂₋ₙFₙ—, and n is 0, 1 or 2; and R⁵ is —CH₃, —C₂H₅ or —C₃H₇; and
R⁶—R⁷—CH₂—COO‘3R⁸ (D)
wherein, R⁶ denotes —CH₃₋ₘFₘ, and m is 1,2 or 3; R⁷ denotes —CH₂₋ₙFₙ—, and n is 0, 1 or 2; and R⁸ is —CH₃, —C₂H₅ or —C₃H₇.

15. The non-aqueous secondary battery according to claim 2, wherein the fluorine-containing ester compound is methyl 2,2,3,3-tetrafluoropropionate or ethyl 2,2,3,3-tetrafluoropropionate.

16. The non-aqueous secondary battery according to claim 3, wherein the fluorine-containing ester compound is methyl 2,2,3,3-tetrafluoropropionate or ethyl 2,2,3,3-tetrafluoropropionate.

17. The non-aqueous secondary battery according to claim 4, wherein the fluorine-containing ester compound is methyl 2,2,3,3-tetrafluoropropionate or ethyl 2,2,3,3-tetrafluoropropionate.

18. The non-aqueous secondary battery according to claim 5, wherein the fluorine-containing ester compound is methyl 2,2,3,3-tetrafluoropropionate or ethyl 2,2,3,3-tetrafluoropropionate.

19. The non-aqueous secondary battery according to claim 2, wherein the non-aqueous electrolyte solvent comprises propylene carbonate, and a content of the propylene carbonate in the non-aqueous electrolyte solvent is 10 vol % or more and 50 vol % or less.

20. The non-aqueous secondary battery according to claim 3, wherein the non-aqueous electrolyte solvent comprises propylene carbonate, and a content of the propylene carbonate in the non-aqueous electrolyte solvent is 10 vol % or more and 50 vol % or less.
